(19) United States
(12) Patent Application Publication
(10) Pub. No.: US 2019/0082081 A1
(43) Pub. Date: Mar. 14, 2019

(54) CIRCUIT APPLIED TO DISPLAY APPARATUS AND ASSOCIATED SIGNAL PROCESSING METHOD

(71) Applicant: MStar Semiconductor, Inc., Hsinchu Hsien (TW)

(72) Inventors: Tzu-Yi Yang, Hsinchu County (TW); Ko-Yin Lai, Hsinchu County (TW); Tai-Lai Tung, Hsinchu County (TW)

(21) Appl. No.: 15/842,071

(22) Filed: Dec. 14, 2017

(30) Foreign Application Priority Data
Sep. 11, 2017 (TW) 106130956

(51) Int. Cl. H04N 5/213; H04N 5/44

(52) U.S. Cl. CPC H04N 5/213; H04N 5/44

(57) ABSTRACT

A circuit applied to a receiver in a display apparatus includes a noise detecting circuit and a threshold determining circuit. The noise detecting circuit detects noise of a received signal to generate a plurality of noise intensity values. The threshold determining circuit determines a threshold according to the plurality of noise intensity values to accordingly determine whether the received signal has impulsive interference. The noise determining circuit includes a sorting circuit and a selecting circuit. The sorting circuit sorts an order of the plurality of noise intensity values. The selecting circuit selects, from the plurality of noise intensity values, the M^{th} noise intensity value as a predetermined noise intensity value. The threshold determining circuit determines the threshold according to the predetermined noise intensity value.

This application claims the benefit of Taiwan application Serial No. 106130956, filed Sep. 11, 2017, the subject matter of which is incorporated herein by reference.

### BACKGROUND OF THE INVENTION

### Field of the Invention

The invention relates in general to signal processing in a display apparatus, and more particularly to an impulsive interference detecting circuit applied to a display apparatus and an associated signal processing method.

### Description of the Related Art

In the Digital Video Broadcasting—Second Generation Terrestrial (DVB-T2) standard, impulsive interference is regarded as an issue that severely affects image display. Impulsive interference has large sudden and periodical amplitudes, and is usually generated by factors in the ambient environment, e.g., an operating washing machine or dishwasher, and a fast automobile passing by. In the prior art, whether a received signal has impulsive interference is determined by means of detecting whether the noise intensity in a signal is higher than a constant threshold. However, such detection method may result in misjudgment. For example, when the threshold is set to an overly high value and the energy of impulsive interference in a signal is weak, the impulsive interference being lower than the threshold may be regarded as a part of common noise, such that whether the signal has impulsive interference cannot be correctly determined. On the other hand, if the threshold is set too low, common noise may be misjudged as impulsive interference. Therefore, there is a need for a solution that provides an appropriate threshold for determining the presence of impulsive interference.

### SUMMARY OF THE INVENTION

It is an object of the present invention to provide a circuit applied to a display apparatus and an associated signal processing method, which are capable of providing an appropriate threshold for accurately determining whether a received signal is affected by impulsive interference so as to solve issues of the prior art.

According to an embodiment of the present invention, a circuit applied to a receiver in a display apparatus includes a noise detecting circuit and a threshold determining circuit. The noise detecting circuit detects noise in a received signal to generate a plurality of noise intensity values. The threshold determining circuit, coupled to the noise detecting circuit, determines a threshold according to the plurality of noise intensity values to accordingly determine whether the received signal has impulsive interference. In one embodiment, the noise determining circuit includes a sorting circuit and a selecting circuit. The sorting circuit sorts an order of the plurality of noise intensity values. The selecting circuit selects, from the plurality of noise intensity values, the M^{th} noise intensity value as a predetermined noise intensity value. The threshold determining circuit determines the threshold according to the predetermined noise intensity value.

According to another embodiment of the present invention, a signal processing method applied to a receiver in a display apparatus includes: performing noise detection on a received signal to generate a plurality of noise intensity values; sorting an order the plurality of noise intensity values; selecting, from the plurality of noise intensity values, the N^{th} smallest noise intensity as a predetermined noise intensity value; and determining a threshold according to the predetermined noise intensity value. The threshold is used to determine whether the received signal has impulsive interference.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a circuit applied to a receiver in a display apparatus according to an embodiment of the present invention;

FIG. 2 is an implementation example of a sorting circuit and a selecting circuit in a threshold determining circuit according to an embodiment of the present invention;

FIG. 3 is a schematic diagram of a plurality of noise intensity values according to an embodiment of the present invention;

FIG. 4 is an implementation example of a sorting circuit and a selecting circuit according to an embodiment of the present invention;

FIG. 5 is a flowchart of a signal processing method applied to a display apparatus according to an embodiment of the present invention;

FIG. 6 is a schematic diagram of a receiver according to an embodiment of the present invention; and

FIG. 7 is a schematic diagram of a frequency-domain signal.

### DETAILED DESCRIPTION OF THE INVENTION

As stated in the description of prior art, determining the presence of impulsive interference by means of a constant threshold can easily result in misjudgment. Therefore, the present invention provides a dynamic threshold determining method for solving the issues of the prior art. In one embodiment, noise of a signal includes common noise (e.g., additive white Gaussian noise (AWGN)) and impulsive interference. Thus, the embodiments of the present invention first determine an intensity of common noise, multiply the intensity of common noise by a ratio parameter (e.g., 2) to generate a threshold, and then determine whether the signal has impulsive interference according to the threshold (e.g., impulsive interference is present if the noise is higher than the threshold). However, when the signal has impulsive interference and the intensity of impulsive interference is weak, the intensity of common noise can overwhelm the impulsive interference. In the above situation, the threshold determined may be higher than the intensity of impulsive interference, causing a failure in determining such impulsive interference having a weak intensity.

To solve the above issue, the present invention further provides a method for dynamically determining a threshold to ensure that the intensity of common noise determined does not include any part associated with impulsive interference, such that whether a signal has impulsive interference can be correctly determined according to a threshold determined according to the intensity of common noise. Associated details are described in the embodiments below.

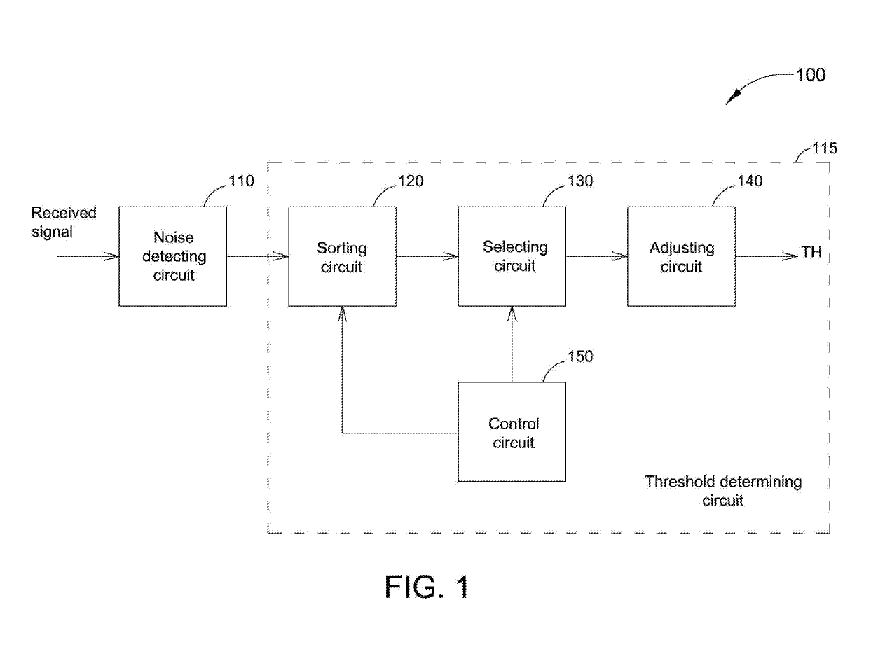

FIG. 1 shows a block diagram of a circuit 100 applied to a receiver in a display apparatus according to an embodiment of the present invention. As shown in FIG. 1, the circuit 100 includes a noise detecting circuit 110 and a threshold determining circuit 115. The threshold determining circuit 115 includes a sorting circuit 120, a selecting circuit 130, an adjusting circuit 140 and a control circuit 150. In this embodiment, the circuit 100 is disposed in a receiver in a television or a set-top box (STB) compliant to the Digital Video Broadcasting—Second Generation Terrestrial (DVB-T2) standard. The circuit 100 is for dynamically determining a threshold TH for the receiver to determine whether a received signal has impulsive interference; that is, it is determined that the received signal has impulsive interference if the noise of the received signal is higher than the threshold TH.

In the circuit 100, the noise detecting circuit 110 performs noise detection on a received signal to sequentially generate a plurality of noise intensity values. For example, assuming that the received signal adopts an orthogonal frequency-division multiplexing (OFDM) modulation scheme, the noise detecting circuit 110 performs noise detection sequentially on a plurality of symbols to generate a plurality of noise intensity values respectively corresponding to the plurality of symbols. The sorting circuit 120 sorts an order of the plurality of noise intensity values received, i.e., sorting the noise intensity values in an increasing or decreasing order. The selecting circuit 130 selects, from the plurality of noise intensity values, the M^{th} noise intensity value as a predetermined noise intensity value. In this embodiment, assuming that the number of the plurality of noise intensity values is K, M is between 1 and (K/2), where M and K are individually positive numbers. For example, assuming that the noise detecting circuit 110 generates 16 noise intensity values that are then sorted by the sorting circuit 120, the selecting circuit 130 selects from the noise detecting circuit the 3^{rd} noise intensity value as the predetermined noise intensity value. The adjusting circuit 140 then generates the threshold TH according to the predetermined noise intensity value for the receiver to determine whether the received signal has impulsive interference. Further, the control circuit 150 shown in the diagram is for controlling settings and operations of the sorting circuit 120 and the selecting circuit 130, e.g., determining a sorting method of the sorting circuit 120 and the value M in the selecting circuit 130.

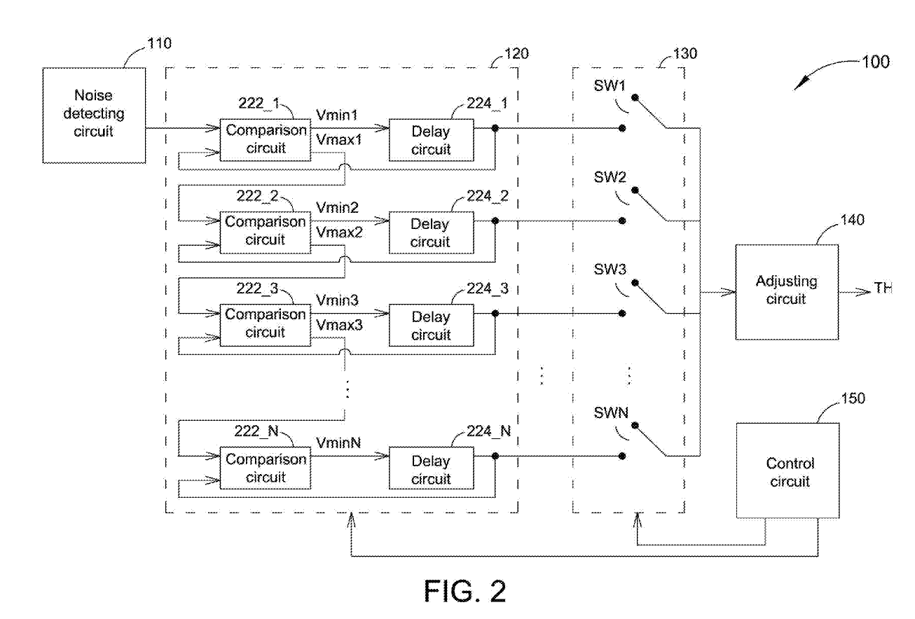

FIG. 2 shows an implementation example of the sorting circuit 120 and the selecting circuit 130 according to an embodiment of the present invention. As shown in FIG. 2, the sorting circuit 120 includes a plurality of comparison circuits 222_1 to 222_n and a plurality of delay circuits 224_1 to 224_N, and the selecting circuit 130 includes a plurality of switches SW1 to SWN. With respect to operations of the sorting circuit 120 and the selecting circuit 130, the comparison circuit 222_1 receives the 1^{st} noise intensity value generated by the noise detecting circuit 110, and utilizes the 1^{st} noise intensity as a minimum noise intensity value Vmin1 that is then outputted to the delay circuit 224_1. The comparison circuit 222_1 receives the 2^{nd} noise intensity value generated by the noise detecting circuit 110, and compares the 2^{nd} noise intensity value with the 1^{st} noise intensity value outputted from the delay circuit 224_1—the lower noise intensity value between the two is utilized as the minimum noise intensity value Vmin1 and outputted to the delay circuit 224_1, whereas the higher noise intensity value Vmax1 is transmitted to the comparison circuit 222_2 at the next stage. The operation of the comparison circuit 222_2 is similar to that of the comparison circuit 222_1, i.e., outputting the lower noise intensity value Vmin2 to the delay circuit 224_2 and transmitting the higher noise intensity value Vmax2 to the comparison circuit 222_3 at the next stage. Similarly, the comparison circuits 222_3 to 222_N output the lower noise intensity values Vmin3 to VminN to the delay circuits 224_3 to 224_N, respectively. As previously described, the outputs of the delay circuits 224_1 to 224_N are noise intensity values in an increasing order; that is, the output from the delay circuit 224_1 is the minimum noise intensity value, the output of the delay circuit 224_2 is the 2^{nd} smallest noise intensity value, the output from the delay circuit 224_3 is the 3^{rd} smallest noise intensity value, and so forth.

The control circuit 150 controls the selecting circuit 130 to select the M^{th} noise intensity value as an output. For example, the control circuit 150 can keep the switch SW3 conducted and the remaining switches turned off (not conducted), such that the selecting circuit 130 outputs the 3^{rd} noise intensity value as the predetermined noise intensity value.

The adjusting circuit 140 performs predetermined calculation on the predetermined noise intensity value. For example, the adjusting circuit 140 may serve as a scaling circuit to multiply the predetermined noise intensity value by a ratio parameter (e.g., 2) to generate a product as the threshold TH. In another embodiment, the ratio parameter may also be set as “1”, or the adjusting circuit 140 is omitted and the output from the selecting circuit 130 is directly used as the threshold TH.

It should be noted that, in the embodiment in FIG. 2, the numbers of the comparison circuits 222_1 to 222_N, the delay circuits 224_1 to 224_N and the switches SW1 to SWN may be determined according to actual hardware requirements or limitations. In one embodiment, because the selecting circuit 130 only needs to output the 3^{rd} noise intensity value, the value of N may be “3”, i.e., the embodiment in FIG. 2 needs only to be provided with three sets of comparison circuits, delay circuits and switches.

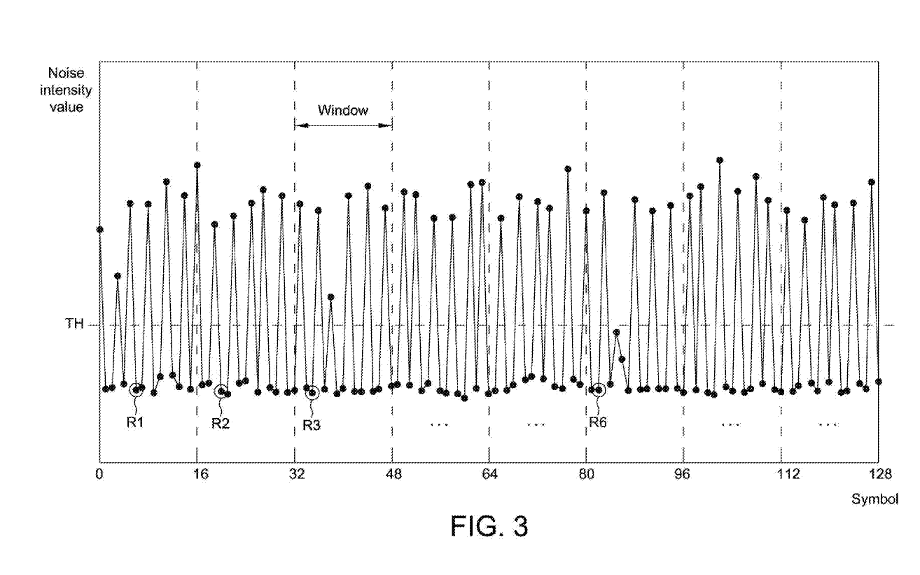

FIG. 3 shows a schematic diagram of a plurality of noise intensity values according to an embodiment of the present invention. As shown in FIG. 3, the horizontal axis represents symbols (which may also be regarded as “time”), and the vertical axis represents noise intensity values. In the example in FIG. 3, operations of the noise detecting circuit 110, the sorting circuit 120 and the selecting circuit 130 are in a unit of one window of the signal, and each window includes multiple symbols (16 symbols in this embodiment). In the operation of one window, the selecting circuit 130 outputs the 3^{rd} noise intensity value (e.g., R1, R2, R3 and R6 in the diagram) as the predetermined noise intensity value to the adjusting circuit 140. After each window ends, the control circuit 150 clears all values stored in the sorting circuit 120 so as to perform the operation of the next window. As shown in FIG. 3, even the probability of a symbol having impulsive interference is quite high, the design of the embodiment can still ensure that the predetermined noise intensity value outputted by the selecting circuit 130 is an intensity value of common noise (e.g., AWNG) without including any part associated with impulsive interference. In this embodiment, when the threshold TH determined by the adjusting circuit is about twice of common noise (as shown in the diagram, for illustrative purposes), this threshold TH can be accurately used to determine whether each symbol has impulsive interference. More specifically, referring to FIG. 3, assuming that the threshold TH determined by the threshold determining circuit 140 is twice the intensity value of common noise, because the noise intensity value of impulsive interference is significantly higher than the threshold TH whereas the noise intensity of common noise is significantly lower than the threshold TH, the threshold TH determined can be used to accurately determine impulsive interference.

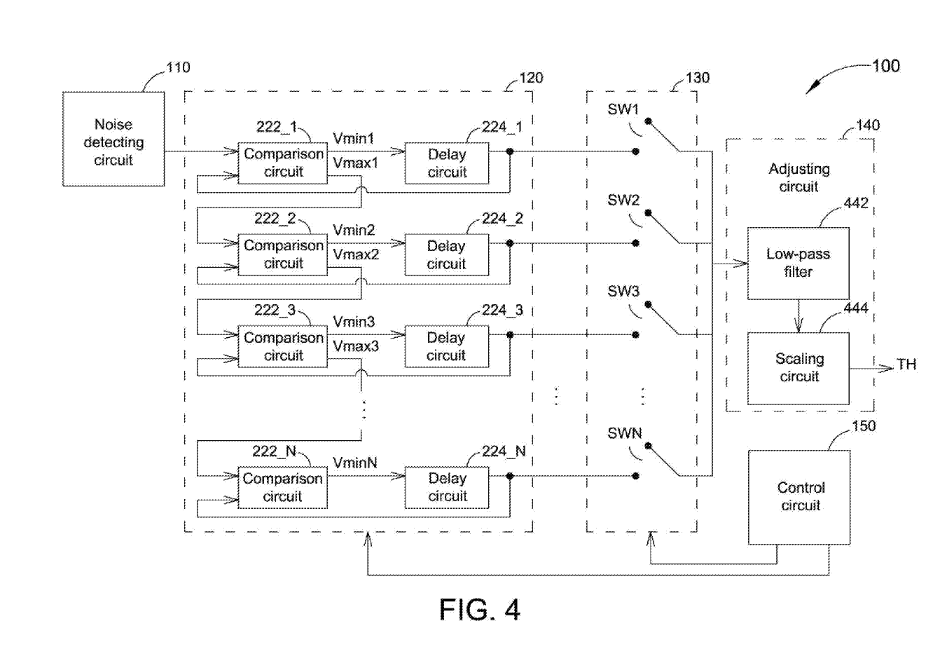

In the description associated with the embodiment in FIG. 2, the adjusting circuit 140 includes a scaling circuit that multiplies the predetermined noise intensity by a ratio parameter to generate a product as the threshold TH. However, in other embodiments, the adjusting circuit 140 may further include other circuits. Referring to FIG. 4, the adjusting circuit 140 includes a low-pass filter 422 and a scaling circuit 444. The low-pass filter 442 performs a low-pass filter process (i.e., a smoothing process) on the predetermined noise intensity value that the selecting circuit 130 outputs in different windows, so as to prevent from generating thresholds that are too small due to multiple inappropriately small noise intensity values in a certain window. The scaling circuit 444 multiplies the filtered predetermined noise intensity value by a ratio parameter (e.g., 2) to generate a product as the threshold TH.

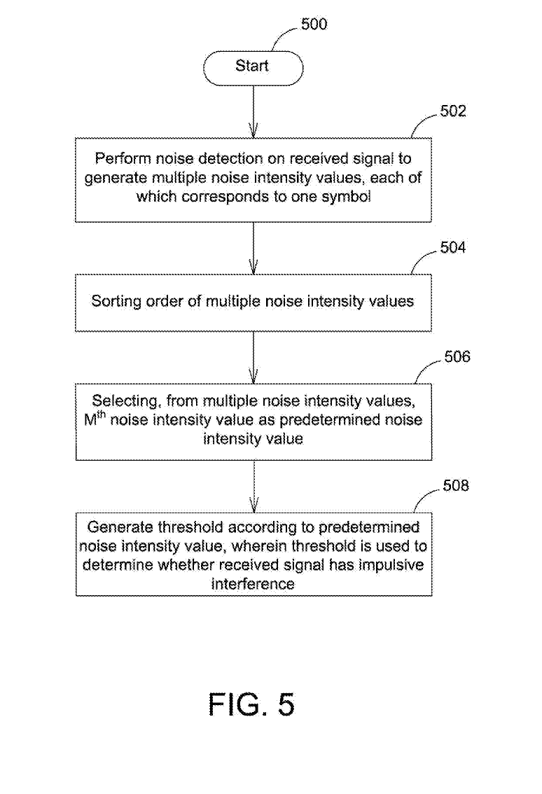

FIG. 5 shows a flowchart of a signal processing method applied to a display apparatus according to an embodiment of the present invention. Referring to the description associated with FIG. 1 and FIG. 4, the process in FIG. 5 are given in detail as below.

In step 500, the process begins.

In step 502, noise detection is performed on a received signal to generate a plurality of noise intensity values, each of which corresponds to one symbol.

In step 504, the plurality of noise intensity values are sorted in order.

In step 506, the M^{th} noise intensity value from the plurality of noise intensity values is selected as a predetermined noise intensity value.

In step 508, a threshold is generated according to the predetermined noise intensity value, wherein the threshold is used to determine whether the received signal has impulsive interference.

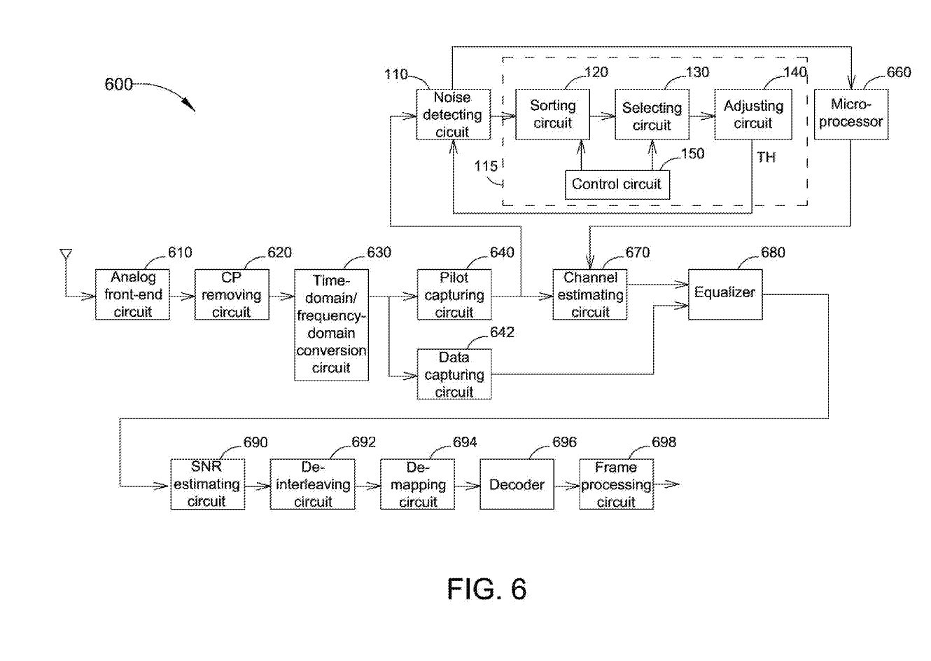

The circuit 100 is applicable to a receiver in a display apparatus. FIG. 6 shows a schematic diagram of a receiver 600 according to an embodiment of the present invention. As shown in FIG. 6, the receiver 600 includes an analog front-end circuit 610, a cyclic prefix (CP) removing circuit 620, a time-domain/frequency-domain conversion circuit 630, a pilot capturing circuit 640, a data capturing circuit 642, the noise detecting circuit 110, the threshold determining circuit 115 including the sorting circuit 120, the selecting circuit 130, the adjusting circuit 140 and the control circuit 150, a microprocessor 660, a channel estimating circuit 670, an equalizer 680, a signal-to-noise ratio (SNR) estimating circuit 690, a de-interleaving circuit 692, a de-mapping circuit 694, a decoder 696 and a frame processing circuit 698. In this embodiment, the receiver 600 is a receiver disposed in a television or STB, and is compliant to the DVB-T2 standard. The receiver 600 process an analog input signal from an antenna, and generates an output signal to a back-end processing circuit in the television or STB for further display on a screen. Further, the analog input signal received by the receiver 600 adopts an OFDM modulation scheme.

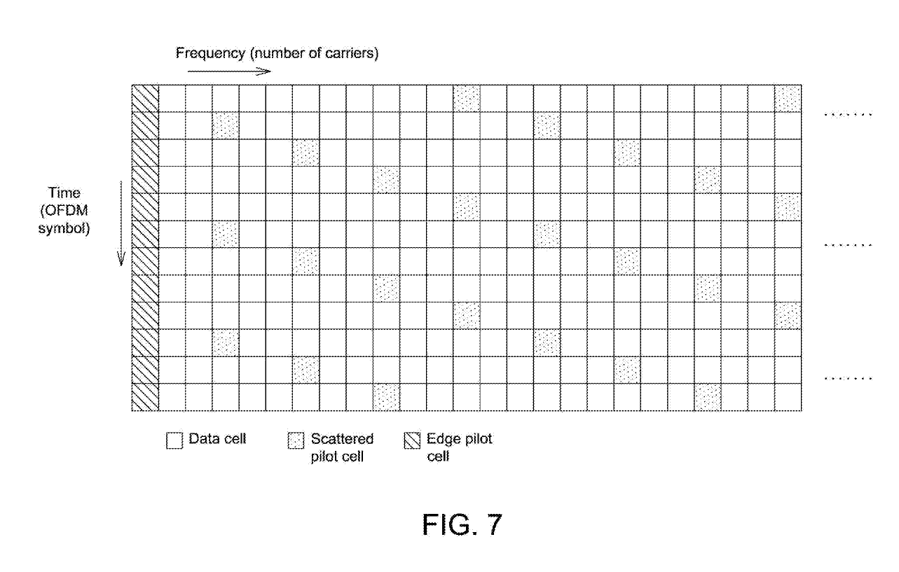

In the receiver 600, the analog front-end circuit 610 processes the analog input signal from an antenna to generate a digital input signal. More specifically, the analog front-end circuit 610 can include components such as a radio-frequency (RF) to intermediate frequency (IF) mixer, a bandpass filter, an analog-to-digital converter (ADC), an IF to baseband mixer and a low-pass filter, so as to process the received analog input signal to generate the digital input signal. The CP removing circuit 620 removes a cyclic prefix from the digital input signal to generate a CP removed digital input signal. The time-domain/frequency-domain conversion circuit 630 converts the CP removed signal from a time domain to a frequency domain to generate a frequency-domain signal, and may be implemented by a fast Fourier transform (FFT) operation. Referring to FIG. 7 showing a schematic diagram of the frequency-domain signal, where the vertical axis represents OFDM symbols at different time point, each row represents one OFDM symbol, each OFDM symbol includes an edge pilot cell, a plurality of data cells and a plurality of scattered pilot cells. Further, the horizontal axis in FIG. 7 represents frequency, and each column can correspond to different sub-carriers.

The pilot capturing circuit 640 captures a plurality of pilot cells (which may be edge pilot cells and/or scattered pilot cells, with scattered pilot cells being used as an example in the description below) of one symbol from the frequency-domain signal. Operations of the noise detecting circuit 110, the sorting circuit 120, the selecting circuit 130, the adjusting circuit 140 and the control circuit 150 are as previously described. Further, the noise detecting circuit 110 performs noise detection sequentially on a plurality of symbols according to the plurality of pilot cells captured by the pilot capturing circuit 640 to generate a plurality of noise intensity values respectively corresponding to the plurality of symbols. Further, in this embodiment, the noise detecting circuit 110 may be used as an impulsive interference detecting circuit, so as to determine whether the symbol has impulsive interference according to the noise intensity values of the plurality of pilot cells and the threshold TH generated by the threshold determining circuit 115 to generate a detection result. It should be noted that, the noise detecting circuit 110 generates the noise intensity value corresponding to a symbol without referring to the noise intensity of a plurality of data cells. Next, the microprocessor 660 controls the channel estimating circuit 670 to adopt different calculation methods to calculate, according to the detection result, a channel frequency response corresponding to the symbol in the frequency-domain signal. On the other hand, the data capturing circuit 642 captures a plurality of data cells of the symbol from the frequency-domain signal, and the equalizer 680 performs equalization on the plurality of data cells according to the channel frequency response calculated by the channel estimating circuit 670 to generate an equalized signal. The SNR estimating circuit 690 performs SNR estimation on the equalized signal according to the estimation result of the channel estimating circuit 670 to generate an estimated SNR result and provides the estimated SNR result to the microprocessor 660 to serve as reference for signal processing. The de-interleaving circuit 692 performs a de-interleaving operation on the equalized signal to generate a de-interleaved signal. The de-mapping circuit 694 performs a de-mapping operation on the de-interleaved signal to generate a plurality of code words. The decoder 696 performs low-density parity-check (LDPC) code and Bose-Chaudhuri-Hocquenghem (BCH) code decoding to obtain a plurality of decoded signals for further processing by the subsequent frame processing circuit 698.

In summary, in the circuit applied to a display apparatus of the present invention, the M^{th} noise intensity value, from a plurality of noise intensity values, is selected as the intensity of common noise, and the value of M is smaller than one-half of the number (i.e., quantity) of the plurality of noise intensity values. Thus, it is ensured that the noise intensity value selected does not include any part associated with impulsive interference, and whether a signal has impulsive interference can be correctly determined according to the threshold determined according to the intensity of common noise.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A circuit, applied to a receiver in a display apparatus, comprising:
a noise detecting circuit, performing noise detection on a received signal to generate a plurality of noise intensity values; and
a threshold determining circuit, coupled to the noise detecting circuit, determining a threshold according to a predetermined noise intensity value selected from the plurality of noise intensity values, wherein the threshold is used to determine whether the received signal has impulsive interference, the threshold determining circuit comprising:
a sorting circuit, coupled to the noise detecting circuit, sorting an order of the plurality of noise intensity values; and
a selecting circuit, coupled to the sorting circuit, selecting one of the plurality of noise intensity values as the predetermined noise intensity value from the sorted order of the plurality of noise intensity values, wherein the threshold determining circuit determines the threshold according to the predetermined noise intensity value;
wherein the sorting circuit comprises:
a first comparison circuit, comparing two noise intensity values to generate a first minimum noise intensity value and a first maximum noise intensity value;
a first delay circuit, coupled to the first comparison circuit, delaying the first minimum noise intensity value to generate one of the two noise intensities, wherein the other between the two noise intensity values is from the noise detecting circuit;
a second comparison circuit, coupled to the first comparison circuit, comparing the first maximum noise intensity value with another noise intensity value to generate a second minimum noise intensity value and a second maximum noise intensity value; and
a second delay circuit, coupled to the second comparison circuit, delaying the second minimum noise intensity value to generate the other noise intensity value.

2. The circuit according to claim 1, wherein the predetermined noise intensity value is the M^{th} noise intensity value of the sorted order, where a quantity of the plurality of noise intensity values is K, and M is between 1 and (K/2), wherein K is greater than or equal to 2, and M is equal to 1 if K is equal to 2.

3. The circuit according to claim 1, wherein the threshold determining circuit further comprises:
a scaling circuit, multiplying the predetermined noise intensity value by a ratio parameter to obtain the threshold.

4. The circuit according to claim 1, wherein the threshold determining circuit further comprises:
a low-pass filter, performing a low-pass filtering operation on the predetermined noise intensity value to generate a filtered predetermined noise intensity value; and
a scaling circuit, coupled to the low-pass filter, multiplying the filtered predetermined noise intensity value by a ratio parameter to obtain the threshold.

5. The circuit according to claim 4, wherein operations of the noise detecting circuit, the sorting circuit and the selecting circuit are in a unit of a window of the received signal, the selecting circuit outputs the predetermined noise intensity value corresponding to each window, and the low-pass filter generates the filtered predetermined noise intensity value according to a plurality of predetermined noise intensity values respectively corresponding to a plurality of windows.

6. The circuit according to claim 5, wherein the threshold determining circuit further comprises:
a control circuit, coupled to the sorting circuit and the selecting circuit, when the sorting circuit and the selecting circuit have completed the operations of one window of the received signal, the control circuit controlling values stored in the sorting circuit and the selecting circuit.

7. The circuit according to claim 1, wherein the received signal is an analog input signal, the circuit further comprising:
an analog front-end circuit, converting the analog input signal to a digital input signal; and
a time-domain/frequency-domain conversion circuit, coupled to the analog front-end circuit, converting the digital input signal from a time domain to a frequency domain to generate a frequency-domain signal;
wherein, the noise detecting circuit performs noise detection on the frequency-domain signal to generate the plurality of noise intensity values.

8. The circuit according to claim 7, wherein the frequency-domain signal comprises a plurality of symbols, each of the plurality of symbols comprises a plurality of pilot cells, the circuit further comprising:
a pilot capturing circuit, coupled between the time-domain/frequency-domain conversion circuit and the noise detecting circuit, capturing the plurality of pilot cells of each symbol from the frequency-domain signal;
wherein, the noise detecting circuit generates the noise intensity value corresponding to each symbol according to noise intensities of the plurality of pilot cells in the symbol.

9. The circuit according to claim 8, wherein each symbol further comprises a plurality of data cells, and the noise detecting circuit generates the noise intensity value corresponding to each symbol without referring to corresponding noise intensities of the plurality of data cells.

10. (canceled)

11. A signal processing method, applied to a receiver in a display apparatus, comprising:
performing noise detection on a received signal to generate a plurality of noise intensity values;
sorting an order of the plurality of noise intensity values;
selecting one of the plurality of noise intensity values as the predetermined noise intensity value as a predetermined noise intensity value from the sorted order of the plurality of noise intensity values; and
determining a threshold according to the predetermined noise intensity value selected from the plurality of noise intensity values, wherein the threshold is used to determine whether the received signal has impulsive interference;
wherein the step of sorting the order of the plurality of noise intensity values comprises:
comparing two noise intensity values to generate a first minimum noise intensity value and a first maximum noise intensity value;
delaying the first minimum noise intensity value to generate one of the two noise intensities, wherein the other between the two noise intensity values is from one of the plurality of noise intensity values;
comparing the first maximum noise intensity value with another noise intensity value to generate a second minimum noise intensity value and a second maximum noise intensity value; and
delaying the second minimum noise intensity value to generate the other noise intensity value.

12. The signal processing method according to claim 11, wherein the predetermined noise intensity value is the M^{th} noise intensity value of the sorted order, where a quantity of the plurality of noise intensity values is K, and M is between 1 and (K/2), wherein K is greater than or equal to 2, and M is equal to 1 if K is equal to 2.

13. The signal processing method according to claim 11, wherein the step of generating the threshold according to the predetermined noise intensity value comprises:
multiplying the predetermined noise intensity value by a ratio parameter to obtain the threshold.

14. The signal processing method according to claim 11, wherein the step of generating the threshold according to the predetermined noise intensity value comprises:
performing a low-pass filtering operation on the predetermined noise intensity value to generate a filtered predetermined noise intensity value; and
multiplying the filtered predetermined noise intensity value by a ratio parameter to obtain the threshold.

15. The signal processing method according to claim 14, wherein the steps of generating the plurality of noise intensity values, sorting the order of the plurality of noise intensity values, and selecting, from the plurality of noise intensity values, the M^{th} noise intensity value are performed in a unit of a window of the received signal; the step of performing the low-pass operation on the predetermined noise intensity value to generate the filtered predetermined noise intensity value comprises:
generating the filtered predetermined noise intensity value according to a plurality of predetermined noise intensity values respectively corresponding to a plurality of windows.

16. The signal processing method according to claim 15, wherein the steps of sorting the order of the plurality of noise intensity values, and selecting, from the plurality of noise intensity values, the M^{th} noise intensity value are performed by a sorting circuit and a selecting circuit, respectively, the signal processing method further comprising:
controlling values stored in the sorting circuit and the selecting circuit when the operation of one of the windows of the received signal is completed.

17. The signal processing method according to claim 11, wherein the received signal is an analog input signal, the signal processing method further comprising:
converting the analog input signal to a digital input signal; and
converting the digital input signal from a time domain to a frequency domain to generate a frequency-domain signal;
wherein, the step of performing the noise detection on the received signal to generate the plurality of noise intensity values comprises:
performing the noise detection on the frequency-domain signal to generate the plurality of noise intensity values.

18. The signal processing method according to claim 17, wherein the frequency-domain signal comprises a plurality of symbols, each of the plurality of symbols comprises a plurality of pilot cells, the signal processing method further comprising:
capturing a plurality of pilot cells of each symbol from the frequency-domain signal; and
the step of performing the noise detection on the frequency-domain signal to generate the plurality of noise intensity values comprises:
generating the noise intensity value corresponding to each symbol according to noise intensities of the plurality of pilot cells in the symbol.

19. The signal processing method according to claim 18, wherein each symbol further comprises a plurality of data cells, and the step of generating the corresponding noise intensity value performs determination without referring to corresponding noise intensities of the plurality of data cells.

20. (canceled)
